(19) United States
(12) Patent Application Publication
(10) Pub. No.: US 2022/0056760 A1
(43) Pub. Date: Feb. 24, 2022

(54) Screen Installation Improvements

(71) Applicant: FlexScreen LLC, Murrysville, PA (US)

(72) Inventor: Joseph A. Altieri, JR., Pittsburgh, PA (US)

(21) Appl. No.: 17/516,683

(22) Filed: Nov. 1, 2021

Related U.S. Application Data
(63) Continuation-in-part of application No. 16/250,930, filed on Jan. 17, 2019, now abandoned.

(51) Int. Cl. E06B 9/52

(52) U.S. Cl. CPC E06B 9/52; E06B 2009/527

(57) ABSTRACT

Disclosed are bumpers for ensuring a screen frame remains where it is placed in a window or door opening when there is insufficient retaining mechanisms. Methods for assisting with the installation and retainer of screens into window or door frames are also provided. The bumpers are made from a deformable and resilient material such as a dense elastomer and are attached to a distal surface of the screen frames using adhesive tape or glue. When the screen is installed, the bumper deforms and uses frictional force to keep the screen in place.

### CROSS-REFERENCE TO RELATED APPLICATIONS

This application is a continuation-in-part and claims the benefit of U.S. patent application Ser. No. 16/250,930, filed Jan. 17, 2019, entitled “Screen Installation Improvements,” the contents of which are incorporated by reference as if more fully set forth herein.

### BACKGROUND OF THE INVENTION

The invention relates generally to removable window and door screens and more specifically to embodiments of replacement and retrofit screens.

One type of screen that is in common use in modern residential and commercial construction is the type that is held in place in a door or window opening by way of parallel sides of its frame fitting within receiving channels running along one or more parallel sides of the door or window opening. In some cases, these receiving channels are located on the vertical sides of the window or door opening, while in others they are located on the top and bottom horizontal sides of the opening. Typically, at least one of the receiving channels is u-shaped in the sense that it has two walls and a base, while another of the receiving channels may be either a full u-shaped channel or only a partial channel wherein it has either just one retaining wall side or two retaining wall sides of unequal height.

When an original screen that came with a window wears out or is damaged, a replacement screen from the manufacturer can be used, if they are still manufacturing a screen for the window. Alternatively, the original screen may have its mesh replaced, but often, the wood in the window frame has warped or the channels have been damaged or painted over or the screen frame has been bent such that the new or repaired screen does not stay in position on the window or door properly.

One type of replacement screen is set forth in U.S. Pat. No. 9,234,388 to Altieri (the '388 patent), the entire contents of which is hereby incorporated as if more fully set forth herein. The '388 patent teaches a screen comprised of a screen frame and a screen mesh. When assembled as a complete apparatus, the screen mesh and the screen frame form a preselected shape. The frame is comprised of a flexible spring-like material, such as spring steel wire, for at least one of its sides, but does not put any pressure on the window frame for installation. As a result, the replacement screen also typically needs a channel in order to remain in place over the window.

Some window and door openings, however, don't have any channels at all because they were the type of window or door that does not typically have a screen. Another common situation is where a screen holding attachment that was originally installed onto the window frame has been removed or damaged. This situation presents a challenge for the after-market manufacturer of replacement screens because there is no existing infrastructure for holding the screen in place. What is needed is a screen that can be held in place by the existing perimeter even when there aren't any channels.

### SUMMARY OF THE INVENTION

The present invention discloses an installation assistance bumper for an OEM or replacement window or door screen. In embodiments, the installation assistance bumper is installed on a distal surface of the screen leg members so that it contacts the window or door frame. Upon contact, the bumper deforms and creates an area of increased friction that holds the screen in place in situations where there is no other screen retention mechanism such as a channel.

In embodiments, the bumper is formed from a material that is resilient and deformable such as a dense elastomer and optionally has a hollow center to assist with deformation, although a hollow center may not be required for certain materials.

The installation assistance bumper may be attached to the screen at the time of manufacturing or it may be applied by the user. Application is typically performed through the use of adhesive tape, on a distal edge of the screen, to which the bumper is applied. Other attachment methods are also possible, such as welding, adhesion or mechanical fastening.

In further embodiments, a kit will be provided containing one or a plurality of lengths of bumper material for sizing and application by the end user.

### BRIEF DESCRIPTION OF THE DRAWINGS

The features and merits of the present invention will be better understood by reference to the attached drawings. It is to be understood, however, that the drawings are designed for the purpose of illustration only and not as definitions of the limits of the present invention.

FIG. 1 is an elevational view of a window or door screen having bumpers constructed according to an embodiment of the present invention.

FIG. 2 is an isometric view of a portion of a screen, as depicted in FIG. 1, having a bumper disposed thereon.

FIG. 3 is an elevational view of a portion of a screen having bumper consistent with the embodiment depicted in FIG. 1 installed in a window frame.

FIG. 4 is an elevational view of a window or door screen having a bumper constructed in accordance with an embodiment of the present invention.

FIG. 5 is an elevational view of a window or door screen frame having portions of a bumper installed in accordance with certain embodiments of the present invention.

FIG. 6 is an elevational view of a window or door screen frame having portions of a bumper installed in accordance with certain other embodiments of the present invention.

FIG. 7 is an elevational view of a window or door screen frame having portions of a bumper installed in accordance with additional embodiments of the present invention.

### DETAILED DESCRIPTION OF THE INVENTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

Whenever the term “about” is used herein or in the appended claims to modify a feature of an embodiment of the present invention, it is to be construed as referring to the ordinary tolerances related to making and/or measuring the relevant feature. Whenever a range is used herein or in the appended claims to describe a feature of an embodiment of the present invention, the range is to be construed as including the stated or implied end points of the range and every point therebetween.

The present invention provides an improved installation assistance attachment for both original and replacement screens for windows and doors. Where existing window or door perimeter infrastructure comprises a channel, the attachment of the present invention can serve to enable the screen to fit more snugly and to assure a secure fit. Further, where the existing window or door perimeter infrastructure does not have a channel or other retaining device, the disclosed attachment can hold the screen in the desired location by increasing the friction between the screen and the window or door frame.

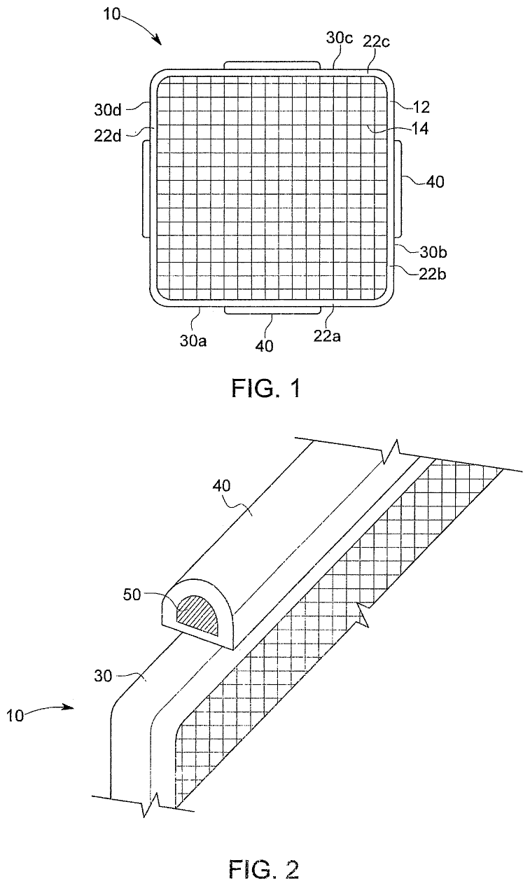

FIGS. 1-3 illustrate a front elevational view of a screen 10 having a frame 12 and screen mesh 14. While there are many different screen shapes, the screen 10 illustrated in FIGS. 1 and 2 has a substantially square frame 12 having a plurality of leg members 22a, b, c and d each having a distal surface 30a-d. In the illustrated embodiment, each leg member has a bumper 40 disposed centrally on each distal surface 30a-d.

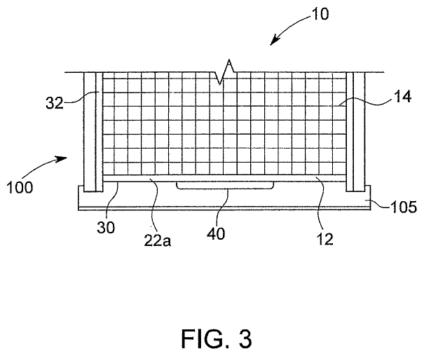

Other embodiments may require the application of a bumper 40 to less than all four leg members. FIG. 3, for example, illustrates a window or door casing 100 having a channel 32 on each vertical side of the screen 10, but no channel along the horizontal bottom leg member 22a. To ensure the screen 10 fits properly and stays in place, a bumper 40 is disposed on the bottom leg member 22a. Due to the weight of the screen 10, the bumper 40 is pressed against the window sill 105. In certain embodiments, when the bumper 40 is pressed against a surface, it flattens out and the surface area of the bumper that comes in contact with the window sill 105 increases, which maximizes the friction afforded by the bumper 40 and helps keep the screen 10 in place.

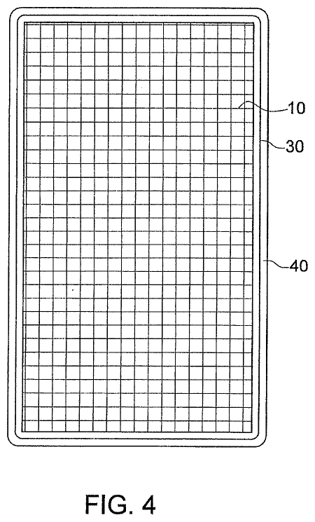

In certain embodiments, each bumper 40 extends less than half the length of the leg member 22a-d and is substantially centered thereon. Other embodiments may cover more or less of the distal surface 30a-d depending on the situation. In one non-limiting example, the screen 10 may be large and heavy, in which case, more friction will be desired between the bumper 40 and the existing window or door casing 100 or sill 105 if no channel 32 is present. In such a case, a greater amount of bumper 40 can be applied to the distal surface of the leg member that presses against the window frame and bears the weight of the screen. In embodiments, the bumper 40 covers the entire distal surface 30 of the leg member 22. Due to the structure and material properties chosen for certain embodiments of bumpers 40, the greater the amount of bumper in contact with the window casing 100 or sill 105, the greater the friction and thus the greater the retaining power of the bumper. In another non-limiting example illustrated by FIG. 4, the bumper 40 can be applied to the entire perimeter to enhance hold in a window frame.

FIG. 2 illustrates an elevational perspective view of a portion of a screen 10 having an embodiment of a bumper 40 disposed on a distal surface 30 of a screen frame 10. In certain embodiments, the bumper 40 is “D-shaped” and has a hollowed out central void 50 for ease of deformation. In other embodiments, the bumper 40 is not “D-shaped” or does not contain a central void 50 but still deforms easily due to the selection of a suitable material. In embodiments, the bumper 40 is disposed on the distal surface 30 using double-faced tape, glue, pressure sensitive adhesive, or other adhesive method. In an embodiment, the bumper 40 is attached to the distal surface 30 using an acrylic-based, double-sided adhesive transfer tape. In still another embodiment, the bumper 40 is mechanically attached to one or more leg members 22 of the screen 10.

Certain embodiments of the bumper 40 are designed to collapse under less pressure than is required to bend the leg members 22a-d, such as when a screen 10 constructed in accordance with the '388 patent has leg members 22 that bend to permit the screen 10 to be installed or removed from the window or door casing 100 and sill 105. As a result, the bumper 20 collapses when the screen is installed and increases the surface area and resulting friction that is applied to the opening perimeter to keep the screen 10 in place, such as when there is no channel.

In certain embodiments, bumpers 40 of the present invention are constructed of a lightweight, compressible material. The material may further be substantially deformed but will return to its original shape when pressure is removed. Suitable materials include dense elastomers, including: natural rubber, SBR (styrene butadiene), EPDM (Ethylene Propylene Diene Monomer), Neoprene, Nitrile, Silicone, FKM (Fluorinated Hydrocarbon), and TPE (thermoplastic elastomer). Other materials may be used of course, so long as they resiliently compress and create friction with an external surface, such as a window frame, when they are compressed.

In certain embodiments, the bumper 40 is applied during manufacture and delivered to the customer already installed. In these embodiments, the bumper 40 may be applied using an adhesive tape, a glue, welding, or through the use of clips or other mechanical fastening means to the distal surface of the screen.

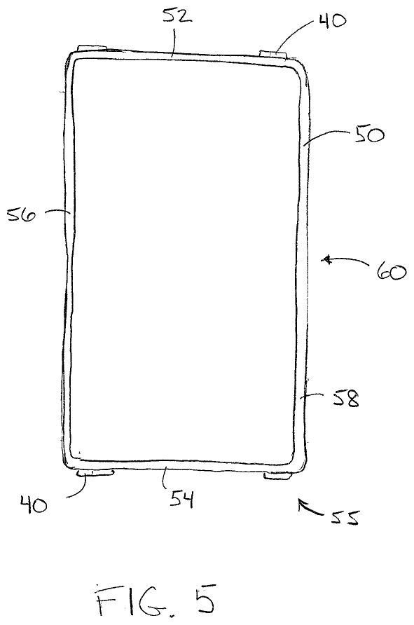

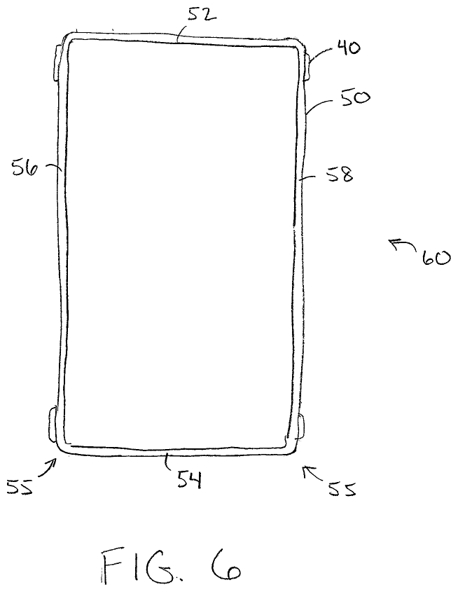

FIGS. 5-7 illustrate certain additional embodiments of the use of bumpers 40 to keep a window or door screen frame 50 in place when insufficient physical restraints, such as channels, are present. It has been discovered that screen frames for screens of the type manufactured in accordance with the teachings of the '388 patent have greater resistance to deformation near screen frame corners 55 than they do near a middle location 60 of a side that is distal to both adjacent corners. Accordingly, it has been discovered that bumpers 40 for these types of screens are more effective at keeping the window in place when they are placed closer to the corner 55 than the middle location.

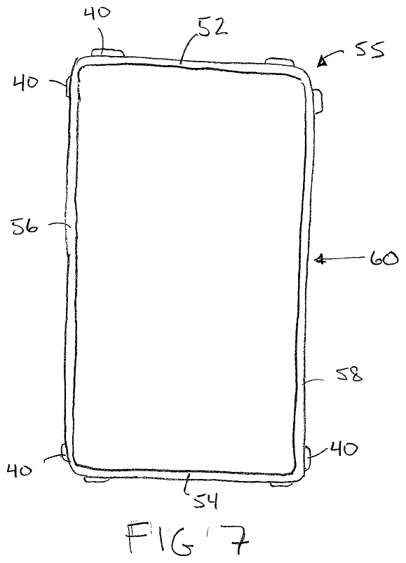

In some embodiments, such as illustrated in FIGS. 5 and 6, the bumpers 40 are only placed on opposing sides of the frame, such as on the top 52 and bottom 54 or left 56 and right 58 sides of the frame 50. In other embodiments, such as illustrated in FIG. 7, the bumpers are affixed (in the manner discussed previously) adjacent to the corners on all four sides of the frame 50. When the screen is deformed by pressing two sides 52, 54 or 56, 58 toward the center of the screen, the bumpers 40 can be positioned in a desired location relative to the external window casing 100 and sill 105. When the pressure on the two sides is released, the bumpers 40 engage with the window or door frame 100 and sill 105 to keep the screen in a desired location. In certain embodiments, the bumpers 40 are less than two inches long.

Other alternative embodiments provide for the delivery of a kit containing a length of bumper material, either standing alone or along with a replacement screen, for the customer to apply as-needed. In this embodiment, the bumper material will have an adhesive tape or film with a backing that can be peeled off the bumper so that it will stick to the distal surface. In some embodiments, the bumper material will be provided as a single length so that the appropriate length can be chosen by the user, such as by cutting the bumper at the appropriate length with a pair of scissors. In other embodiments, multiple lengths of bumper material can be provided in standardized lengths such as twelve inches or eighteen inches.

While only a few embodiments of the present invention have been shown and described, it will be apparent to those skilled in the art that many changes and modifications may be made to the disclosed apparatuses and methods without departing from the spirit and scope of the present invention. All patent applications, patents, and all other publications referenced herein are incorporated herein in their entireties to the full extent permitted by law.

What is claimed is:

1. An installation assistance bumper set for securing a window or door screen in an opening perimeter that does not have sufficient physical restraint to hold the screen in place, the screen having a frame comprising a plurality of connected leg members that meet at corners, each leg member having an outer edge surface and a leg member length, the installation assistance bumper comprising:
a plurality of lengths of deformable material configured to be selectively disposed on the outer edge surface of at least two leg members, wherein the plurality of lengths are disposed proximal to the corners.

2. The bumper set of claim 1, further comprising at least four lengths of deformable material, the lengths are disposed on opposite legs.

3. The bumper set of claim 1, further comprising at least eight lengths of deformable material, the lengths disposed on all legs near the corners.

4. The installation assistance bumper set forth in claim 1, wherein the deformable material is selected from the group consisting of natural rubber, SBR, EPDM, Neoprene, Nitrile, Silicone, FKM, and TPE.

5. The installation assistance bumper set forth in claim 1, wherein the length of deformable material is configured to be secured to the leg members by melting, welding, adhesion or mechanical fastening.

6. A method of preparing a screen to facilitate installation of the screen into an opening perimeter having insufficient mechanical retaining means, the screen having a frame having a plurality of distal surfaces for engaging the window or door frame with a first friction, the method comprising:
fixably applying a plurality of bumpers to one or more distal surfaces of the screen frame, the bumper comprised of a resilient, deformable material, whereby a second friction between the surfaces is created.

7. The method of claim 6, further comprising cutting the plurality of bumpers to a desired length.

8. The method of claim 7, wherein the desired length is less than two inches.

9. The method of claim 6, wherein the second friction is greater than the first friction.

10. A kit for modifying a replacement screen having one or more leg members to be used with a window or door frame lacking securement channels comprising:
one or more lengths of bumper material, the bumper material having a flat surface;
an adhesive to be applied to the flat surface to enable attachment to one or more leg members.
